(19) United States
(12) Patent Application Publication
(10) Pub. No.: US 2007/0192114 A1
(43) Pub. Date: Aug. 16, 2007

(54) Method of automated estate management

(76) Inventor: Davaid J. Parpala, La Habra, CA (US)

Correspondence Address: PATENT LAW & VENTURE GROUP, 2424 S.E. BRISTOL, SUITE 300, NEWPORT BEACH, CA, 92660, US

(21) Appl. No.: 11/342,995

(22) Filed: Jan. 30, 2006

(51) Int. Cl. G06Q 10/00; G06Q 30/00

(52) U.S. Cl. 705/1

(57) ABSTRACT

A method of accumulating and maintaining selected records of a principal and assuring that certain actions take place as requested by the principal including the steps of preparing, in digital form, an inventory database of personal, medical, legal and financial information of the principal. The personal information includes a set of desired actions to be carried out routinely and upon change of status of the principal. A password enables digital access to the inventory database by the principal and an associate at a host Web site available through the Internet. A communication schedule establishes routine and emergency communications from the host to both principal and associate. If either the principal or the associate are non-responsive to the routine notices, the other is informed. When status of the principal has changed, the host automatically notifies pre-selected individuals and services.

### CROSS-REFERENCE TO RELATED APPLICATIONS

Not applicable

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to methods of estate management and more particularly to a computer network based system for keeping records and managing an estate especially during key events such as the death of the primary user.

2. Description of Related Art including information disclosed under 37 CFR 1.97 and 1.98

Fallon, U.S. 2002/0111946, discloses an invention that provides a system and method for assisting individuals in putting their affairs in order using a universal integrated organizer with personal legacy planning and personal on-line storage. The system includes a secure Web site that allow a user to assemble and submit documents, records, lists of information, etc., that form part of a comprehensive estate plan and also documents of a personal nature. Certain documents and information such as medical records, tax returns, etc., can also be submitted by other individuals. The system organizes the information and documents in a set of folders such as a Personal Folder, Medical Folder, Legal Folder, and Financial Folder. The system encrypts the information before transmission to the Web site. The information is stored securely and can subsequently be accessed and changed only by the user. Upon the death or incapacitation of the user or other designated condition, the stored information can be accessed by authorized representatives such as a trusted individual through financial institutions such as a bank or insurance company. In certain embodiments of the invention public key cryptography is used for security purposes. Sheem, U.S. 2002/0116306, discloses a system and method for a family fund management based on an Internet family web site in which family funds dedicated to some of the relatives dispense monetary rewards to pre-verified beneficiaries. The financial details on the family funds in terms of the principal amount, income from the principal, dispensable amount, past transactions, are readily available for display on the web site in a self-explanatory fashion. The clarity of the financial transactions and the transparency of the financial details allow the family web site being steered largely in an auto-pilot mode, thus contribute to preserving the family web site over many generations at a reasonable financial management cost and to reducing the possibility of financial fraud substantially. It could be preferable to dispense the dedicated family funds only during one short period during the year, such as a few days around Christmas or New Year day. Parker, U.S. 2003/0182290, discloses a method for facilitating final estate planning (FEP) that comprises gathering data in response to a series of questions organized into four points of estate planning, which are (1) client assets, (2) client fiscal and human/pet care responsibilities (i.e. creditors, children, spouse, employers and others that are dependent upon the client), (3) desired disposition of the client's body before (e.g., assisted living, hospice, palliative care, life support) and after death (corporal disposition), and (4) funding arrangements and documentation for asset disposition to cover fiscal, human/pet care responsibilities, living body and subsequent remains disposition, and to carry out the client's other wishes. A system for performing the method includes a computer program that is preferably accessible via an internet web site. A unique identification card, known as a Denicard™, is provided which includes information for accessing the bearer's or owner's end of life (EOL) plans and data that is stored in a database accessible via a the web site or a designated entity, wherein the stored data is generated by the system when the FEP method was performed. Numerous variations of FEP and EOL planning methods and systems and products for implementation are described. These can be incorporated into a total life plan. Taminori, JP 2000208865, discloses a death report method by which false information showing that a living person is dead can be prevented, accurate and secure death report information can be announced officially, and high security is secured when death report information is officially announced through the Internet as business by receiving an order from a publication requester. The death report information is inputted from a publication requester terminal to a homepage for input which is opened on the Internet and registered in a database for input that an administrator side manages and after the administrator side obtains acknowledgement by requesting the publication requester to confirm the contents of the death report information, the death report information registered in the database for input is transferred to a data base for official announcement that the administrator side manages, so that the information is made open to the public through a homepage for official announcement opened separately from the homepage for input. Yuji, JP 2002049709, discloses a system for drawing a detailed quotation and contract for a funeral service at an arbitrary time, prior to death by utilizing the Internet. A funeral estimate and contract system server machine is provided with a database for storing estimate applicants/funeral contractors, detailed quotation information, funeral attendant information, information on a temple for holding the funeral service and contract information or the like and by accessing this server machine through the Internet, an estimate applicant can obtain the detailed estimate of the funeral and further can draw a funeral contract. Funeral service is stated, by sending mail of the report of the death from the server machine to the Internet terminals of the chief mourner/relatives, attendants and a temple to hold the funeral service, an after the death of the funnel contractor is confirmed.

Our prior art search described above teaches the use of computer systems for estate management and especially the keeping of personal, medical, financial and legal records. However, the prior art fails to teach an interactive computer network and system capable of assuring dynamic interplay between key designated individuals and a primary user referred to herein as the principal. The present disclosure discloses such a system and method and distinguishes over the prior art providing heretofore unknown advantages as described in the following summary.

### BRIEF SUMMARY OF THE INVENTION

This disclosure teaches certain benefits in construction and use which give rise to the objectives described below.

A significant problem in maintaining the records of ones estate is the inherent difficulty in keeping such records current and up-to-date. A related problem arises when a principal of the estate, i.e., a person to whom assets in the estate belong, becomes incapacitated or dies. Who will be notified? Who will notify them? What if the principal is not responsive but family and/or friends are not aware of this? The present disclosure describes a method for accumulating and maintaining estate records for a principal person, referred to herein as the “principal,” and assuring that certain desired actions take place upon the incapacitation, death or loss of contact with the principal. Such estate records include personal, legal, financial and medical records. The present method includes the steps of preparing estate records and placing them in digital form (data) into an estate database. The method further includes the step of placing the database under the care of a third party service along with a set of instructions as to what routine actions shall be taken, and what extraordinary actions shall be taken.

Since the data, the instructions, and the identity of the principal are confidential, steps are taken to assure that only those with approved passwords are able to gain access to them. A routine communication schedule and a contingency communication schedule, as required by the set of instructions is established. An associate is identified; a person who will take action depending on the disposition of the principal.

A primary objective inherent in the above described method is to provide advantages not taught by the prior art.

Another objective is to establish an automated information system that; operated by a third party organization, is able to provide for routine and extraordinary communications.

A further objective is to provide such a system that will make an estate database available to an associate depending upon the disposition of the principal.

A still further objective is to enable automated responses from the information system when requests to the host or the associate are not received.

Other features and advantages of the described apparatus and method of use will become apparent from the following more detailed description, taken in conjunction with the accompanying drawing, which illustrates, by way of example, the principles of the presently described method.

### BRIEF DESCRIPTION OF THE SEVERAL VIEWS OF THE DRAWING(S)

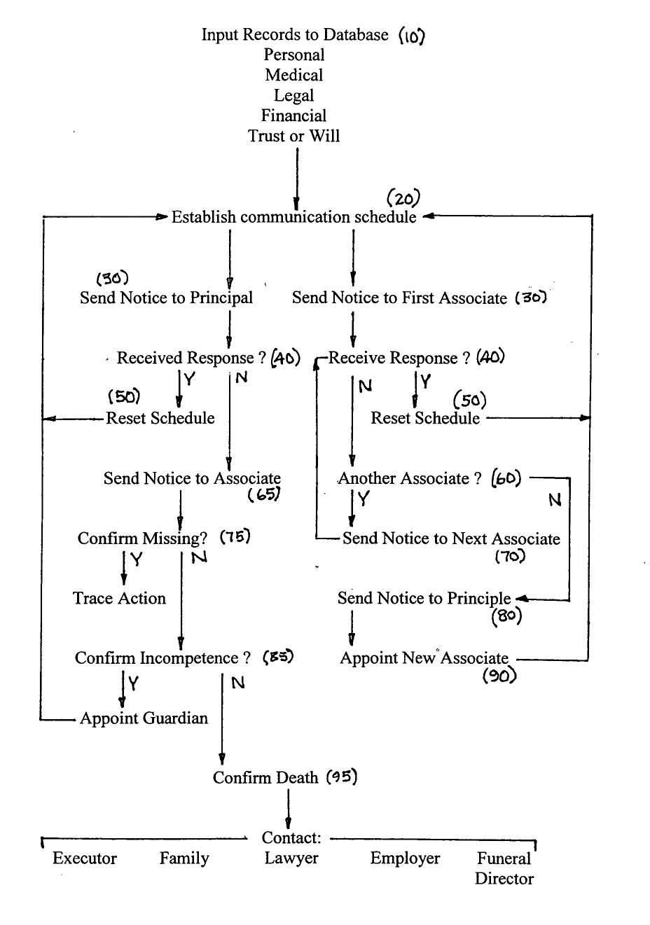

The accompanying drawing illustrates a best mode embodiment of the present method. In such drawing FIG. 1 is a logical flow diagram of the method.

### DETAILED DESCRIPTION OF THE INVENTION

The above described drawing figure illustrates the present method in its preferred embodiment, which is further defined in detail in the following description. Those having ordinary skill in the art may be able to make alterations and modifications to what is described herein without departing from its spirit and scope. Therefore, it must be understood that what is illustrated is set forth only for the purpose of example and that it should not be taken as a limitation of the scope of the present method.

The present invention is a method of accumulating and maintaining selected records concerning a principal, and assuring that certain actions take place as requested by the principal depending upon the principal's disposition. The principal may be a person, a family, a group of individuals, a business, or other entities, the foregoing list being considered non-exhaustive. The word “principal” as applied herein also refers to a surrogate that may act, usually in a legal capacity for the principal person. However, the principal, must be identified by name with contact information including an email address, and if more than one person, a priority order of contact must be defined. If the principal is a single individual, then an associate must be identified by name and contact information including an email address. The associate may be an individual or a plurality of individuals, and if the latter, again, a priority order of contact must be defined. Typically, the associates are family members of the principal, or close friends, or business partners, etc.

The method includes the following steps. An inventory of personal, medical, legal and financial information concerning the principal is prepared and placed into digital form. This data is placed into a database maintained by a third party service (host) and made accessible via the Internet. Further, information defining a set of desired actions is programmed into a software protocol operated by the host. A code key or password is provided to enable digital access to the database, i.e., from any computer having access to the Internet; by both the principal and the associate. Levels of access may be formed such as to change and add to the database by the principal, but read only access to the associate. Such storage of data in a database and provision for gaining access to the database by those having a password is notoriously well known so that details need not be further explained here.

Following the instructions of the principal, a communication schedule is set up including routine communications and extraordinary communications. The routine communications are conducted automatically through a host's software protocol preferably supported by an active web site operated by the host. The routine communications include periodic email messages sent from the host to the principal as reminders to update the database if such is necessary and may include weekly, monthly or quarterly message for instance. Automated dispersing of email messages is well known in the art but not with respect to the present method. In response to these routine email inquiries, the principal is required to log onto the host Internet site, enter the principal's password and take routine action to satisfy the host program that all is well. If this action is not taken within a given period, the host is programmed to contact the associate informing the associate that the principal is non-responsive. Now, it should be understood that the host may be programmed to send a plurality of messages to the principal prior to alerting the associate. This plurality of messages may be scheduled to be sent in an ever increasing frequency, for instance, or a similar protocol such as with an ever heightened message of warning or alarm.

The routine communications may also include periodic email messages sent from the host to the associate to assure the host that the associate is still in communication and available. Such messages to the associate may include weekly, monthly or quarterly message for instance as with the principal. If the associate has been placed in charge of updating the database for the principal and has been therefore given the password to enable such, the principal may not have any responsibility for updating or adding to the database, and may need not respond to the host protocol at all, this task being assumed by the associate. Typically, however, the host protocol is set to expect responses from the principal within a response time duration window and when such are not received, and lack of response is confirmed by a designated number of backup attempts without answers, an alert is emailed to the associate. If the principal or his/her surrogate, a nurse for instance, does contact the host, a “Status of Principal” may be changed from active to non-active when the principal is disabled or incapacitated. When this occurs, the associate is automatically inform by email of the event.

Email notifications to the associate are made when a response to emailed notifications is not received from the host, i.e., an alert is triggered. Also, email notifications to the associate are made automatically when a notice of host incapacity is received from the host.

As an example of the present method, when the principal is an individual, the personal information stored in the database includes information such as: the principal's full name, address, phone numbers, date of birth, social security number, driver's license number, employer, funeral arrangements, family and friends, clergy, membership organizations, military history, list and location of valuable personal assets, list and location of valuable papers, location of keys to secure locations including post office boxes and safe deposit boxes; and medical information includes information concerning at least one of: medical practitioners, hospital, personal and family medical history; and legal information includes information concerning at least one of: attorneys, outstanding legal actions, last will and testament, family living trust; and financial information includes information concerning at least one of: financial assets, social security agency, lenders, accountant, bank officers, insurance agents, stock broker, tax preparer, and trust officer.

It is clear from the foregoing that the present method is an information system capable of meeting the primary objective of maintaining a communication system and implementing predetermined actions in case an element, e.g., associate, principal, etc. of the communication system becomes unresponsive. The method provides for establishing and maintaining a database of personal, medical, legal and financial records of a principal whereby such records are made available to an associate upon the occurrence of certain events, including lack of response or determination of failure to be responsible by the principal. With such a system in place, the principal is able to feel comfortable that his estate will be cared for if he/she is unable to do so, and will be distributed in accordance with his/her wishes and in a timely manner upon his/her death.

Now referring to FIG. 1, the present method specifically teaches the steps of inputting data 10 into a database associated with an Internet site or host, and establishing a communication schedule 20, primarily a schedule of automated email queries. The method includes sending 30 these routine notices on a regular basis as described above. As shown, if these notices are recognized 40 the schedule is reset 50 and the next cycle is started according to the schedule. If no response is received by the host within a selected time period, the host looks to see if an alternate associate has been designated 60 and if so a notice is sent to the alternate 70. If this is received 40, the schedule is reset as before. If there is no alternate associate or if the last alternate associate has been notified but no response received, a notice is sent to the principal and a new associate is appointed 90. If a routine notice to the principal is not responded to, a notice is sent to the associate 65 informing the associate that the principal is not responding. The associate would investigate and determine that the principal is either missing 75, has become incompetent 85, or has died 95. The associate responds to the host by logging onto the Internet site and selecting an appropriate button, e.g., “missing,” “incompetent,” or “deceased.” The host then initiates action by email correspondence or otherwise. If the principal is missing, the host informs a missing person's tracing agency of the identity and is authorized to fund a trace action using assets of the principal's estate. If the principal is incompetent, the host informs a guardian or care service to establish care for the principal and the associate appoints a surrogate to act for the principal in receiving and responding to the routine notices from the host. If the principal has expired as confirmed by the associate, the host releases a plurality of email messages to the appointed executor, family members, the appointed lawyer, the principal's employer, the appointed funeral director and other persons as identified in the input records. The entire information communication system as shown in FIG. 1 is able to operate according to a protocol with little support from the individuals involved and is therefore able to meet the needs of a wide range of situations such as when the principal is located in a different country or is not in a position to be able to maintained records concerning his/her estate.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

What is claimed is:

1. A method of accumulating and maintaining selected records of a principal and assuring that certain actions take place as requested by the host, the method comprising the steps of: preparing, in digital form, an inventory database accessible through a host on the Internet, of personal, medical, legal and financial information of the principal including specific actions to be carried out and persons to be contacted if the principal is missing, judged legally incompetent, or found deceased; appointing an associate; providing password access for the principal and the associate to the inventory database; establishing a communication schedule and thereby sending routine repetitive messages to the principal and the associate; monitoring responses from the principal and the associate; informing the principal when the associate is non-responsive so as to provide for setting up an alternate associate; informing the associate when the principal is non-responsive so as to provide for verification by the associate of the status of the principal as missing, incompetent or deceased; informing previously appointed individuals to establish action in accordance with the status of the principal.

2. The method of claim 1 wherein the associate comprises plural individuals and when one of said individuals is non-responsive, contacting each further of said individuals in turn.

3. The method of claim 1 wherein when the status of the principal is missing, communicating with a previously appointed missing persons agency.

4. The method of claim 1 wherein when the status of the principal is incompetent, communicating with a previously appointed care agency.

5. The method of claim 1 wherein when the status of the principal is deceased, communicating with a previously appointed individuals including at least one of: amily members, employer, lawyer, employer, and funeral director.

6. The method of claim 1 wherein the inventory database includes information concerning at least one of: principal's full name, address, phone numbers, date of birth, social security number, driver's license number, employer, funeral arrangements, family and friends, clergy, membership organizations, military history, list and location of valuable personal assets, list and location of valuable papers, location of keys to secure locations including post office boxes and safe deposit boxes; and medical information includes information concerning at least one of: medical practitioners, hospital, personal and family medical history; and legal information includes information concerning at least one of: attorneys, outstanding legal actions, last will and testament, family living trust; and financial information includes information concerning at least one of: financial assets, social security agency, lenders, accountant, bank officers, insurance agents, stock broker, tax preparer, and trust officer.
